(19) United States
(12) Patent Application Publication
(10) Pub. No.: US 2012/0055425 A1
(43) Pub. Date: Mar. 8, 2012

(54) ENGINE CONFIGURATION FOR A MOTOR VEHICLE

(75) Inventor: Torsten MUELLER, Ruesselsheim (DE)

(73) Assignee: GM GLOBAL TECHNOLOGY OPERATIONS LLC, Detroit, MI (US)

(21) Appl. No.: 13/221,443

(22) Filed: Aug. 30, 2011

(30) Foreign Application Priority Data
Sep. 6, 2010 (DE) 102010044472.3

(51) Int. Cl. F02N 19/04; F01P 11/00

(52) U.S. Cl. 123/41.55; 123/142.5 R

(57) ABSTRACT

An engine configuration for a motor vehicle is provided that has an internal combustion engine having direct fuel injection, which is thermally coupled to a cooling circuit to dissipate waste heat occurring in operation, and having a storage unit, which can be coupled to the cooling circuit, for storing thermal energy, which is implemented for the purpose of discharging store thermal energy to the cooling circuit and/or to the engine before the engine is put into operation and/or during a warm-up phase thereof.

### CROSS-REFERENCE TO RELATED APPLICATION

This application claims priority to German Patent Application No. 102010044472.3, filed Sep. 6, 2010, which is incorporated herein by reference in its entirety.

### TECHNICAL FIELD

The technical field relates to an engine configuration, which has an internal combustion engine having direct fuel injection, and a method for heating an internal combustion engine before and/or when it is put into operation and/or during a warm-up phase.

### BACKGROUND

Stricter exhaust gas standards and corresponding statutory provisions provide increasingly improved and environmentally-compatible exhaust gas quality of internal combustion engines. In accordance with the rising requirements with respect to permissible limiting values of exhaust gases and exhaust gas components as well as soot particles or similar materials contained in the combustion exhaust gas, the vehicle producers and engine developers are encouraged to further optimize the combustion procedures in the internal combustion engine.

It has been shown that the combustion only reaches an advantageous untreated emission composition with increasing temperature of the engine. In a starting or warm-up phase of the engine, i.e., from the starting time until reaching a predefined operating temperature, which is typically around approximately 90° C.-105° C., for example, the mixture formation of the fuel cannot be performed optimally. As a result, in particular in the starting or warm-up phase of an internal combustion engine, the permissible limiting values for the chemical substances and particles contained in the engine exhaust gas are exceeded under certain circumstances.

Furthermore, experiments have shown that in particular in engines having direct fuel injection, in particular having direct gasoline injection, condensing of the fuel can occur, namely if a fuel-air mixture is injected into the still relatively cold combustion chamber of the engine. Condensate formation can occur in particular in this case on the still comparatively cold inner wall sections of the cylinder or the piston inner wall. Phenomena such as local over-enrichment of the fuel mixture can occur in this case, which could result in increased soot formation in the combustion procedure.

The swirling and time span for the formation of a fuel mixture by the direct injection of the fuel into the combustion chamber of the engine is also comparatively short in internal combustion engines having direct fuel injection. The mentioned problems with respect to fuel condensation or local-over enrichment can therefore have particularly severe consequences in the case of direct-injection internal combustion engines for the quality of the exhaust gas and for the noncompliance with required exhaust gas standards, in particular in the starting or warm-up phase of the engine.

It is therefore the object to reduce the exhaust gas quality and in particular the soot and fine dust component of the exhaust gas in the starting and/or warm-up phase of a motor vehicle internal combustion engine. It is a further object to provide by the most minor possible design measures and structural alterations of a motor vehicle engine configuration and implement with low cost and production expenditure. In addition, other objects, desirable features and characteristics will become apparent from the subsequent summary and detailed description, and the appended claims, taken in conjunction with the accompanying drawings and this background.

### SUMMARY

The engine configuration is designed for a motor vehicle and has an internal combustion engine having direct fuel injection. Furthermore, a cooling circuit is provided, with which the internal combustion engine is thermally coupled to dissipate its waste heat occurring in operation. A storage unit is further provided for the storage of thermal energy, which can be coupled to the cooling circuit and is implemented for the purpose of discharging stored thermal energy to the cooling circuit and/or directly to the engine before the internal combustion engine is put into operation and/or during a starting or warm-up phase of the internal combustion engine.

In this way, the temperature of the engine components, in particular of the engine block or those areas of the engine which directly adjoin the combustion chamber, can advantageously already be warmed up before the internal combustion engine is put into operation and/or during a warm-up phase directly chronologically following the putting into operation. Condensing of the fuel on the previously comparatively cold inner walls of the combustion chamber can therefore be effectively counteracted and the pollutant emission, in particular the particle formation, can be reduced during the starting and/or warm-up phase of the engine. The fuel consumption in the warm-up phase can also be reduced and the warm-up phase per se can be shortened in time by the improved, in particular accelerated heating of the engine.

In a first embodiment, the storage unit has a reservoir for a heat storage medium. The reservoir can alternately be coupled to the cooling circuit of the engine configuration and also decoupled therefrom again in this case, in order to exchange thermal energy between the cooling circuit and the heat storage medium located in the reservoir of the storage unit, or to be able to thermally isolate heated or comparatively hot heat storage medium. The reservoir of the storage unit or the storage unit per se is preferably implemented as highly thermally insulated, so that even in the event of comparatively low external temperatures and also after a longer shutdown of the engine, sufficient thermal energy can still be available in the storage unit in order to be able to accelerate or shorten the heating procedure of the engine. The sizes of the storage unit and its reservoir are dimensioned according to the size and the heat capacity of the engine and its components and according to the fillable volume of the cooling circuit. The storage unit is thus implemented to absorb and store excess waste heat of the engine in operation of the internal combustion engine, in particular to provide this stored thermal energy to the engine again as needed, in particular before or during a cold start of the engine.

Thus, according to an embodiment the storage unit can furthermore exclusively be thermally coupled to the engine via the cooling circuit. In this way, the design expenditure for implementing a passive heating unit for the internal combustion engine can be kept relatively low. In the simplest embodiment, for example, only the attachment of a thermal energy storage unit to the cooling circuit provided in any case, in particular a coolant circuit of the engine configuration, is to be provided. In this case, retrofitting already existing engine concepts and corresponding engine configurations with the described storage unit is even conceivable. Alternatively thereto, it is also conceivable to thermally couple the storage unit directly to the engine or to the engine components, so that in particular a heat transfer from the storage unit to the internal combustion engine can optionally also be performed independently of the cooling circuit of the engine configuration.

In a further embodiment, the engine configuration further has a pump or conveyor unit, which is implemented for the purpose, independently of the operating state of the engine, of supplying the engine with the thermal energy stored in the storage unit. In this case, for example, the heat storage medium contained in the reservoir of the storage unit can be introduced into the cooling circuit of an internal combustion engine which is still shut down or has just been put into operation. For this purpose, the preferably electrically implemented pump or conveyor unit can be actuated independently of the operating state of the engine, in order to supply the comparatively hot or warm heat storage medium, which is stored in the storage unit, to the cooling circuit and/or the engine.

In an embodiment, in particular the coolant which circulates in the cooling circuit in any case, in particular cooling water, which is typically admixed with an anti-freeze agent, is provided as the heat storage medium. The storage unit is implemented for receiving coolant heated in operation of the engine and for the time-delayed discharge of received coolant to the cooling circuit. Instead of typical cooling water as a heat storage medium, however, other heat storage media can fundamentally also be used in this case. The time-delayed discharge of received or stored coolant to the cooling circuit is preferably performed via a controller or regulator, which substantially independently recognizes or detects that the engine is imminently to be put into operation and correspondingly activates a pump or conveyor unit for heating the engine, for example.

Furthermore, according to an embodiment, a latent heat storage material can be provided as the heat storage medium, which is received in the storage unit or in its reservoir, which is highly thermally insulated to the outside. Latent heat storage materials use a phase transition or a change of their aggregate state to store thermal energy. In particular salts or paraffins are used as latent heat storage materials.

Furthermore, if a latent heat storage material is used in the storage unit, it is advantageous to provide an additional heat exchanger in or on the storage unit, in order, depending on the demand and operating state of the engine, either to introduce thermal energy into the heat storage material, or to discharge released latent heat to the cooling circuit, for example, and therefore indirectly to the internal combustion engine. The latent heat storage material remains in the storage unit in this case.

According to an embodiment, in particular according to a specific embodiment in which the storage unit is directly supplied with the coolant circulating in the cooling circuit, at least one actuating unit, such as an inflow or outflow valve, is provided, using which the storage unit and optionally its reservoir for the heat storage medium can be integrated in regard to flow into the cooling circuit. For example, it can be provided using the actuating unit that the storage unit is incorporated completely into the cooling circuit when the engine is running at operating temperature, so that the storage unit reaches a temperature level comparable to the cooling circuit. For this purpose, further control or regulating means are provided, which actuate the actuating unit if the engine is shut down and/or if the coolant temperature decreases below a predefined threshold value, for example, such that the storage unit is disconnected in regard to flow from the cooling circuit, so that the cooling circuit and/or the engine can be substantially thermally decoupled from the storage unit.

Engine and cooling circuit then cool down to the ambient temperature, while the storage unit keeps the heat storage medium received therein at a temperature level significantly elevated in relation to the ambient temperature over the longest possible period of time, preferably over days. The actuating unit is to be actuated again when or before the engine is put into operation, in order to be able to supply the heat storage medium, which is received in the storage unit and is still relatively warm or hot, to the cooling circuit and therefore to the engine to be heated.

According to a further embodiment, the engine configuration has a regulating module, which, as a function of the temperature of the engine and/or as a function of the temperature of the coolant circulating in the cooling circuit, couples the storage unit to the cooling circuit or decouples it therefrom. Decoupling of storage unit and cooling circuit is particularly to be provided as soon as the temperature of the coolant circulating in the cooling circuit drops below the normal operating temperature of the engine. The regulating module can additionally initiate thermal decoupling of storage unit and engine or of storage unit and cooling circuit in anticipation of a temperature decrease of the coolant.

The regulating module can also be implemented as a separate structural unit. It is preferably integrated in a control module of the internal combustion engine. Since manifold state parameters of the engine and further vehicle parameters are provided in any case in such engine control modules, coupling or decoupling of storage unit and engine, or of storage unit and cooling circuit can be implemented with comparatively minor design expenditure. The attachment of any possible sensors to ascertain the engine or coolant temperature can be superfluous, on the basis of already existing engine concepts.

In a further embodiment thereof, it is additionally provided that the regulating module is coupled to at least one sensor unit, in order to detect an event which chronologically precedes putting the engine into operation, such as the recognition of vehicle door unlocking, vehicle door opening, vehicle seat occupation, and/or ignition activation. As a result of the detection or recognition of such events which typically precede putting an engine into operation, the regulating module is implemented for the purpose of transferring the thermal energy stored in the storage unit to the engine to achieve preheating of the engine. This is advantageously already performed before the engine is actually put into operation, in order to shorten the starting or warm-up phase of the engine as much as possible.

In a further embodiment, the invention further relates to a motor vehicle having an above-described engine configuration, whose internal combustion engine can the heated up or warmed beforehand, i.e., before it is actually put into operation, with the aid of a storage unit for storing thermal energy, which optionally can be thermally coupled to the cooling circuit of the engine.

In a further embodiment, a method is provided for heating up or warming an internal combustion engine of a motor vehicle before it is put into operation and/or during a following warm-up phase of the engine, in a first step, thermal energy being stored in a storage unit which can be coupled to a cooling circuit of the internal combustion engine. The storage of thermal energy is preferably performed in this case in operation of the engine at its provided operating temperature. The thermal energy is stored in this case in the storage unit, for example, using sufficient thermal insulation and/or with the aid of a latent heat storage medium, independently of the respective operating state of the engine.

Before it is again put into operation and/or during a warm-up phase of a cooled-down internal combustion engine, it is provided in a further step that the thermal energy stored in the storage unit is transferred to the cooling circuit and/or to the engine. For this purpose, for example, a separate circulating pump for the coolant or for the cooling circuit can be put into operation, in order to supply the heat storage medium located in the storage unit to the cooling circuit and therefore also to the engine.

According to an embodiment, the storage unit therefore has a reservoir for receiving a heat storage medium, the storage unit being coupled to the cooling circuit in operation of the engine to store thermal energy. In particular, the storage unit can be more or less integrated in the cooling circuit, for example, by opening a corresponding valve.

Decoupling of cooling circuit and storage unit can be performed as a function of temperature, in particular by comparison of the temperature of the coolant or the heat storage medium to a target temperature. It is also conceivable to use the operating state of the engine, in particular the shutdown of an internal combustion engine, as a type of trigger for the thermal decoupling of storage unit and cooling circuit. The heating up or warming of the internal combustion engine before or during a cold or warm-up phase is preferably begun as a result of detection of an event which typically precedes putting the engine into operation. For example, the recognition of vehicle door unlocking, vehicle door opening or closing, vehicle seat occupation, and/or activation of the ignition or the insertion of an ignition key or a similar portable starting and authentication device into a vehicle-side lock provided for this purpose can function as such an event.

### BRIEF DESCRIPTION OF THE FIGURES

The present invention will hereinafter be described in conjunction with the following drawing figures, wherein like numerals denote like elements, and:

FIG. 1 shows a schematic view of an engine configuration having an internal combustion engine, a cooling circuit, and a storage unit which can be coupled thereto; and

FIG. 2 shows a simplified schematic view of a motor vehicle having an engine configuration.

### DETAILED DESCRIPTION

The following detailed description is merely exemplary in nature and is not intended to limit application and uses. Furthermore, there is no intention to be bound by any theory presented in the preceding background or summary or the following detailed description.

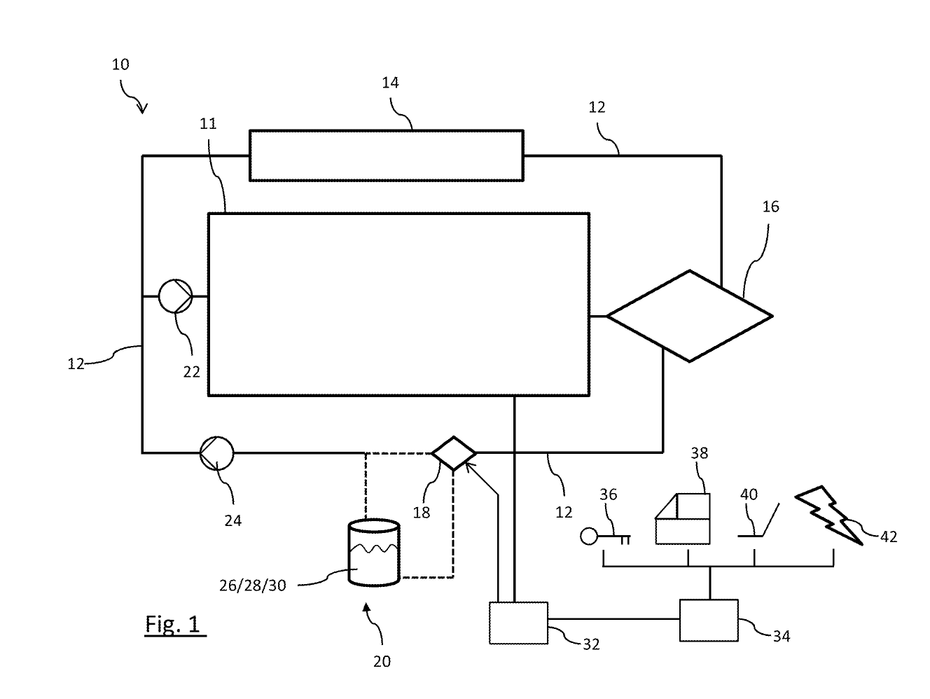

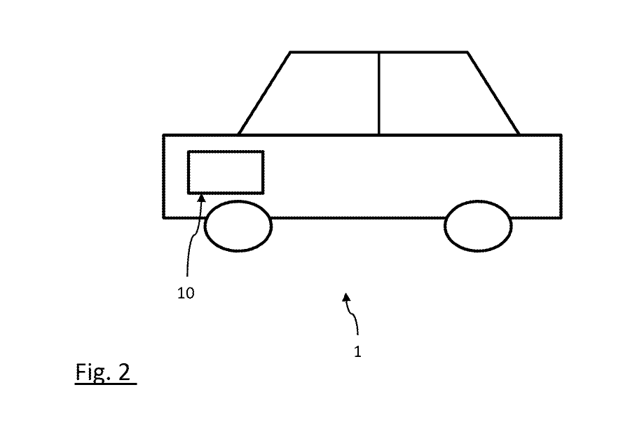

FIG. 2 shows a simplified schematic view of a motor vehicle in the form of a passenger automobile 1, which has an engine configuration 10, which is shown in greater detail in FIG. 1 The engine configuration 10, which is shown in a view similar to a block diagram in FIG. 1, has an internal combustion engine 11, which is in thermal contact with the cooling circuit 12. The engine 11 is equipped with direct fuel injection and can correspondingly be implemented as a diesel or gasoline assembly. The engine is thermally connected to a cooling circuit 12 to dissipate waste heat occurring in operation of the engine 11. The coolant, which is commonly referred to as coolant, is circulated in the cooling circuit 12 via a coolant pump 22 and supplied, depending on the coolant temperature and the configuration and setting of a thermostat 16 thus caused, to a heat exchanger 14, e.g., a water-cooled radiator, to exchange thermal energy with the surroundings.

A storage unit 20 is schematically shown on the bottom in FIG. 1, which can optionally be coupled according to the dashed lines, for example, using a multiple-port valve or a thermostat 16, to the cooling circuit 12. It is particularly provided in this case that comparatively warm or hot heat storage medium 26, in particular a coolant 28, is applied to the storage unit 20, in particular the reservoir contained therein, which is thermally insulated to the outside, or this storage unit has coolant 28 flowing through it, as soon as the coolant temperature has reached a predefined minimum temperature, which typically essentially corresponds to the operating temperature of the engine 11.

After a shutdown of the engine 11, an adjustment or closing of the multiple-port valve 18 and therefore thermal decoupling of cooling circuit 12 and storage unit 20 can be implemented. During the following cool-down phase of cooling circuit 12 and internal combustion engine 11, the comparatively warm or hot coolant contained in the reservoir of the storage unit 20 can be preserved at an elevated temperature level and substantially thermally isolated. Before, during, or immediately after the internal combustion engine 11 is put into operation, but at least before it reaches its operating temperature after it is put into operation again, it is provided that the thermal energy stored in the storage unit is discharged again to the internal combustion engine 11 and/or to the cooling circuit 12 by opening the valve 18, in particular to be able to provide passive and environmentally-friendly prior heating or preheating of the engine 11.

The adjustment or opening of the multiple-port valve 18 can be performed in this case, for example, as a result of detection of an event which typically chronologically precedes putting the engine into operation. Thus, for example, by unlocking the vehicle doors 36, by opening the vehicle doors 38, by occupying a vehicle seat 40, and by activating an ignition 42 or by similar events, the valve 18 can be opened and also a further pump 24 can be put into operation using the regulating module 32, in order to supply the comparatively warm or hot heat storage medium 26, which is received in the storage unit 20 and is accordingly stored thermally isolated, in particular warm coolant 28, to the cooling circuit 12 and thus to the engine 11 already before the engine is actually put into operation. For this purpose, the regulating module 32 is coupled to at least with the valve 18 and with a sensor unit 34, which can recognize actuation of the vehicle lock 36 and/or a vehicle door 38, and the occupation of a seat 40 and the activation of an ignition 42. Furthermore, the regulating module 34 can be directly coupled to the engine 11 and/or to the cooling circuit, in particular to control closing of the valve 18 when the engine 11 is shut down.

The pump 24, which is preferably to be actuated electrically and is powered by a vehicle battery, can also be dispensed with depending on the configuration of storage unit 20 and engine 11, in particular if the storage unit 20, viewed in the vehicle vertical direction, is situated above an intake of the cooling circuit 12 to the engine 11, so that an inflow of stored heat storage medium 26 to the engine 11 can be implemented solely by opening the valve 18, for example, because of gravity, or also by the coolant pump 22. In an alteration thereof, the storage unit 20 can also be implemented to receive a latent heat storage material 30.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An engine configuration for a motor vehicle, comprising:
a cooling circuit configured to dissipate waste heat occurring in operation;
an internal combustion engine having direct fuel injection that is thermally coupled to the cooling circuit; and
a storage unit coupled to the cooling circuit and configured to store thermal energy and implemented to discharge the thermal energy, which is stored before the internal combustion engine is put into operation.

2. The engine configuration according to claim 1, wherein the storage unit is configured to discharge the thermal energy to the cooling circuit.

3. The engine configuration according to claim 1, wherein the storage unit is configured to discharge the thermal energy to the internal combustion engine.

4. The engine configuration according to claim 1, wherein the storage unit has a reservoir for a heat storage medium.

5. The engine configuration according to claim 1, wherein the storage unit is exclusively and thermally coupled to the internal combustion engine via the cooling circuit.

6. The engine configuration according to claim 1, further comprising a conveyor unit that is configured to supply the internal combustion engine with the thermal energy stored in the storage unit independently of an operating state of the internal combustion engine.

7. The engine configuration according to claim 1, wherein the storage unit is configured to receive coolant heated in operation of the internal combustion engine and to discharge the coolant to the cooling circuit in a time-delayed manner.

8. The engine configuration according to claim 1, wherein the storage unit comprises a latent heat storage material that is configured to receive and discharge the thermal energy.

9. The engine configuration according to claim 1, wherein the storage unit is integrated into a flow of the cooling circuit using an actuating unit.

10. The engine configuration according to claim 4, further comprising a regulating module that couples the storage unit to the cooling circuit as a function of a temperature of the internal combustion engine.

11. The engine configuration according to claim 10, wherein the regulating module is coupled to a sensor unit configured to recognize a vehicle door unlocking in order to initiate preheating of the internal combustion engine fed by the heat storage medium.

12. A method for heating up an internal combustion engine, comprising:
storing thermal energy in a storage unit coupled with a cooling circuit of the internal combustion engine; and
transferring thermal energy stored in the storage unit to the cooling circuit before the internal combustion engine is put into operation.

13. The method according to claim 12, further comprising receiving a heat storage medium with a reservoir of the storage unit coupled to the cooling circuit in operation of the internal combustion engine to store the thermal energy.

14. The method according to claim 12, further comprising:
detecting an event that precedes putting the internal combustion engine into operation; and
transferring the thermal energy from the storage unit to the internal combustion engine as a result of this detection.
